(19) United States
(12) Patent Application Publication
(10) Pub. No.: US 2019/0325059 A1
(43) Pub. Date: Oct. 24, 2019

(54) METADATA TAGSETS WITH MULTIPLE PERSONAS IN A STORAGE APPLIANCE

(71) Applicant: EMC IP Holding Company LLC, Hopkinton, MA (US)

(72) Inventors: Robert L. Fair, Cary, NC (US); R. Wesley Fulk, Raleigh, NC (US)

(21) Appl. No.: 15/960,409

(22) Filed: Apr. 23, 2018

(51) Int. Cl. G06F 17/30; G06F 9/54

(52) U.S. Cl. CPC G06F 17/30598; G06F 17/30106; G06F 9/547

(57) ABSTRACT

One example method includes creating a tagset comprising a plurality of metadata tags, associating the tagset with an object that resides in two or more namespaces, creating a first persona and a second persona, wherein from a perspective of the first persona, the object is a first type of object, and from a perspective of the second persona, the object is a second type of object, enabling improved user access to the object by associating the first persona and the second persona with the tagset so that the object is accessible using both a first access method associated with the first persona and using a second access method associated with the second persona, and accessing the object using one or both of the first persona and the second persona.

### FIELD OF THE INVENTION

Embodiments of the present invention generally relate to methods and processes for tagging objects in such a way as to enable improvements in the speed, efficiency, and flexibility, with which data searches are performed. More particularly, at least some embodiments of the invention relate to systems, hardware, software, computer-readable media, and methods directed to creating a metadata tagset having multiple tags that all relate to the same object. The metadata tagset may be associated with multiple unique personas that may each correspond, for example, to a different respective access method or protocol, and the object can be queried and updated using any of the personas.

### BACKGROUND

Conventional storage methods and systems are limited in their effectiveness at least insofar they concern the way in which data is accessed. For example, objects can be searched based on metadata associated with the object. However, the nature of the metadata associated with objects is typically such that the objects can only be accessed with a specific access method or protocol. This circumstance is problematic where there is a need to locate and access the object based on object metadata, but that object metadata does not support the access method or protocol desired to be used to locate and access the object.

Thus, in order to locate and access a particular object without using the specified access method or protocol, resort must be made to the use of a generic inquiry. One example generic inquiry might take the form ‘find all objects that have changed in the last 30 days.’ While the group of objects that fulfill the query may in fact include the object of interest, that group will have to be further examined in order to locate that particular object.

However, depending upon the way in which the query is structured, and the size of the group of objects that fulfill the query parameters, it may be quite time consuming to locate the object of interest, at least because there may be a large number of objects in the group. Thus, the use of generic queries is a slow and highly inefficient way to search for and locate objects that cannot otherwise be located except by using the access method or protocol specifically associated with the object metadata.

### BRIEF DESCRIPTION OF THE DRAWINGS

In order to describe the manner in which at least some of the advantages and features of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an example operating environment including a data protection environment with a commonality engine;

FIG. 2 discloses aspects of an example host configuration;

FIG. 3 discloses aspects of an example tagset and associated personas;

FIG. 4 discloses further aspects of an example system for performing various operations concerning metadata tags and personas;

FIG. 5 discloses aspects of an example tagset and associated objects; and

FIG. 6 discloses aspects of an example method performing various operations concerning metadata tags and personas.

### DETAILED DESCRIPTION OF SOME EXAMPLE EMBODIMENTS

Embodiments of the present invention generally relate to methods and processes for tagging objects in such a way as to enable improvements in the speed, efficiency, and flexibility, with which data searches are performed. More particularly, at least some embodiments of the invention relate to systems, hardware, software, computer-readable media, and methods directed to creating a metadata tagset having multiple tags that all relate to the same object. The metadata tagset may be associated with multiple unique personas that may each correspond, for example, to a different respective access method or protocol, and the object can be queried and updated using any of the personas.

In general, it is useful to add searchable tags to storage objects, examples of which include filesystem files, and cloud objects. The tags are associated with a specific storage object for later reference, such as in connection with a search process. As well, it may be useful for the same set of tags to be associated with a plurality of different logical objects or abstractions depending on the application/user. As such, at least some of the example embodiments disclosed herein provide for a searchable tag store that has one or more personas associated with each set of tags.

As used herein, a persona may comprise, or consist of, a key-value combination, such as a namespace-name combination. Some illustrative examples of a namespace include a file namespace, path, and a virtual-disk namespace with a disk universally unique identifier (UUID). In some embodiments at least, the UUID is a 128-bit number used to identify information in a computer system. As well, each of the personas may correspond, for example, to a particular respective access method or protocol.

By associating multiple personas with a tagset, the object naming and searching of object tags can use the most natural, or relevant, form of referencing a tagset. Further, updates to the tagset are always consistent regardless of the persona used. That is, because the personas refer to a common tagset, changes to that common tagset are, in essence, populated across all of the personas that have been associated with the tagset, although the personas themselves are not changed, and do not need to be changed, when the tagset is modified.

Thus, embodiments of the invention may involve a loose one-to-many (1:M) relationship between a given set of tags and the namespaces/names, that is, personas, used to reference that set of tags. This approach allows, for example, a given, unique, tagset to be referenced by multiple names depending on the application domain. As noted, personas may be dynamically added and removed without changing the underlying set of tags.

Advantageously then, embodiments of the invention implement a flexible approach to searching in which the search for a given object can be performed in connection with multiple different access methods and protocols. Correspondingly, such embodiments eliminate the need for the use of inefficient and time consuming generic object search processes.

Details concerning various example embodiments are set forth in the ‘Appendix A to Utility Patent Application Atty. Docket 16192.206’ attached hereto, and incorporated herein in its entirety by this reference so as to form a part of this disclosure.

A. Aspects of An Example Operating Environment

The following is a discussion of aspects of example operating environments for various embodiments of the invention. This discussion is not intended to limit the scope of the invention, or the applicability of the embodiments, in any way.

In general, embodiments of the invention may include and/or be implemented in a data protection environment such as a cloud services environment that may be, or include, a data protection system operating environment that includes one or more storage systems or storage environments including primary storage and data protection storage. In some specific example embodiments of the invention, at least some functionality may be provided by, or implemented in connection with, a platform such as the Dell-EMC DataDomain data protection platform, and associated systems, methods, and components, although use of this particular platform is provided only by way of illustration and is not required.

The storage environment may take the form of a cloud storage environment, an on-premises storage environment, and hybrid storage environments that include public and private elements, although the scope of the invention extends to any other type of storage environment as well. More generally, embodiments of the invention can be implemented in any suitable environment, including a cloud services environment, and the scope of the invention is not limited to the example environments disclosed herein. Any of these cloud environments, or other operating environments, can take the form of an operating environment that is partly, or completely, virtualized.

The storage environment may include one or more host devices that each host one or more applications used by a client of the storage environment. As such, a particular client may employ, or otherwise be associated with, one or more instances of each of one or more applications. In general, the applications employed by the clients are not limited to any particular functionality or type of functionality. Some example applications and data include email applications such as MS Exchange, database applications such as SQL Server, filesystems, as well as datastores such as Oracle databases for example. The applications on the clients may generate new and/or modified data that is desired to be protected.

Any of the devices, including the clients, servers and hosts, in the operating environment can take the form of software, physical machines, or virtual machines (VM), or any combination of these, though no particular device implementation or configuration is required for any embodiment. Similarly, data protection system components such as databases, storage servers, storage volumes, storage disks, backup servers, restore servers, backup clients, and restore clients, for example, can likewise take the form of software, physical machines or virtual machines (VM), though no particular component implementation is required for any embodiment. Where VMs are employed, a hypervisor or other virtual machine monitor (VMM) can be employed to create and control the VMs.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files, contacts, directories, sub-directories, volumes, and any group of one or more of the foregoing.

Example embodiments of the invention are applicable to any system capable of storing and handling various types of objects, in analog, digital, or other form. Although terms such as document, file, block, or object may be used by way of example, the principles of the disclosure are not limited to any particular form of representing and storing data or other information. Rather, such principles are equally applicable to any object capable of representing information.

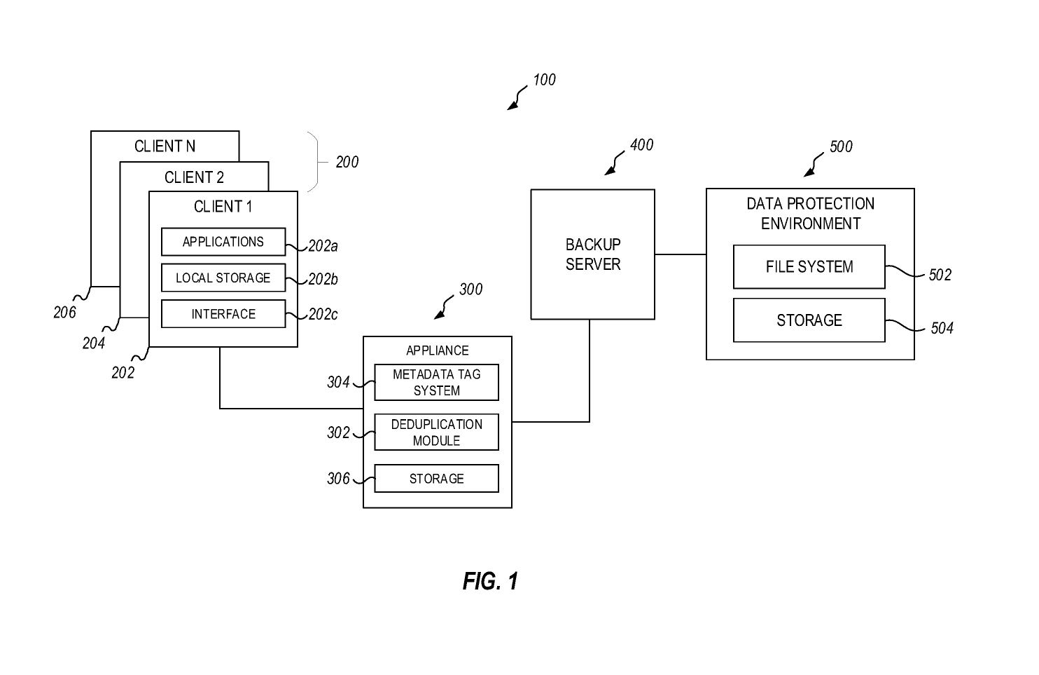

With particular reference now to FIG. 1, an example operating environment 100 may include a plurality of clients 200, such as clients 202, 204 and 206. Client 202 may host one or more applications 202a, and may include local storage 202b, as well as an interface 202c for communicating with other systems and devices, such as the storage appliance 300 for example. Clients 204 and 206 may be configured similarly, or identically, to client 202, although that is not required.

In general, the applications 202a may create new and/or modified data that is desired to be protected. As such, the clients 200 are examples of host devices. One, some, or all, of the clients 200 may take the form of a VM, although that is not required. In general, the VM is a virtualization of underlying hardware and/or software and, as such, one or more of the clients 200 may include or otherwise be associated with various underlying components. The local storage 202b can be used to locally store data, which may be backed up as disclosed herein. The backup data can be restored to the local storage 202b. While not specifically indicated, the client 202 may include a backup client application that cooperates with a backup server 400, to create backups of client 200 data for storage in a data protection environment 500.

With continued reference to FIG. 1, the storage appliance 300 of the example operating environment 100 may, but is not required to, take the form of the Dell-EMC CloudBoost appliance, by way of which one or more clients 200 are able to communicate with a backup server 400. The backup server 400 may be a stand-alone entity, or can be an element of the data protection environment 500. In some embodiments, the backup server 400 may be an EMC Corp. Avamar server or an EMC Corp. Networker server, although no particular server is required for embodiments of the invention.

In the example of FIG. 1, backup data is communicated from the clients 200 to the storage appliance 300 for initial processing, after which the processed backup data is uploaded from the storage appliance 300 to the backup server 400 for storage at the data protection environment 500. A backup application (not shown) of the backup server 400 may cooperate with a backup client application (not shown) of one of the client 202, 204 and 206 to back up client 200 data to the data protection environment 500, such as by uploading data to the data protection environment 500. As well, the backup application of the backup server 400 may cooperate with a backup client application (not shown) of one of the clients 202, 204 and 206 to restore backed up data from the data protection environment 500 to one or more of the clients 202, 204 and 206.

In more detail, the data protection environment 500 may include one or more instances of a filesystem 502 that catalogues files and other data residing in the data protection environment 500, and the data protection environment 500 also includes storage 504. In general, the storage 504 is configured to store client 200 data backups that can be restored to the clients 200 in the event that a loss of data or other problem occurs with respect to the clients 200. The term data backups is intended to be construed broadly and includes, but is not limited to, partial backups, incremental backups, full backups, clones, snapshots, any other type of copies of data, and any combination of the foregoing. Any of the foregoing may, or may not, be deduplicated. The storage 504 can employ, or be backed by, a mix of storage types, such as Solid State Drive (SSD) storage for transactional type workloads such as databases and boot volumes whose performance is typically considered in terms of the number of input/output operations (10PS) performed. Additionally, or alternatively, the storage 504 can use Hard Disk Drive (HDD) storage for throughput intensive workloads that are typically measured in terms of data transfer rates such as MB/s.

In some embodiments, the data protection environment 500 comprises, or consists of, the Dell-EMC Data Domain data protection environment, although that particular configuration is not required. The data protection environment 500 may be implemented as a Dell-EMC DataDomain data protection environment, although that is not required. The data protection environment 500, may comprise or consist of datacenter, which may be a cloud storage datacenter in some embodiments, that is accessible, either directly or indirectly, by the clients 200.

As noted earlier, the example operating environment 100 of FIG. 1 includes a storage appliance 300. Embodiments of the storage appliance 300 may provide a variety of useful functionalities. For example, some embodiments of the storage appliance 300 can provide source-side data deduplication, data compression, and WAN optimization boost performance and throughput while also possibly reducing the consumption and cost of network bandwidth and cloud storage capacity. One, some, or all, of these functions of the storage appliance 300 can be performed by a deduplication module 302.

As well, embodiments of the storage appliance 300 can be implemented in various forms, such as a virtual, physical, or native public cloud appliance to fit the requirements of a particular situation, and the storage appliance 300 can be used with various types of data protection environments 500, including public and private object storage clouds.

Further, embodiments of the storage appliance 300, particularly the deduplication module 302, can provide data segmentation, as well as in-flight encryption as the data is sent by the storage appliance 300 to the data protection environment 500. Data transfers between the storage appliance 300 and data protection environment 500 can be effected with HTTPS. As used herein, HTTPS refers to communication over Hypertext Transfer Protocol (HTTP) within a connection encrypted by Transport Layer Security (TLS), or its predecessor, Secure Sockets Layer (SSL).

Example embodiments of the storage appliance 300 may also include a metadata tag subsystem 304. In general, and as disclosed in more detail elsewhere herein, the metadata tag subsystem 304 may perform a variety of functions. For example, the metadata tag subsystem 304 may serve to generate metadata tags, define tagsets that include one or more metadata tags, and assign tagsets to one or more objects that are to be backed up in the data protection environment 500. The metadata tag subsystem 304 may also operate to modify metadata tagsets, and delete metadata tagsets. As well, the metadata tag subsystem 304 may assign, either on its own or in response to a command from another entity, one or more personas to a tagset. In the same manner, the metadata tag subsystem 304 may remove one or more personas from association with a tagset.

In some embodiments, one or more functions implemented by the metadata tag subsystem 304 may be performed in response to user input. Thus, for example, a user may define the content of the metadata tagsets, the personas, and may specify the association of the personas with a metadata tagset, as well as the association of a metadata tagset with one or more objects. Further details concerning the creation and use of metadata tags, tagsets, and personas are disclosed elsewhere herein.

Finally, at least some embodiments of the storage appliance 300 may include local storage 306 where metadata tagsets and metadata tags are stored. Further details concerning storage of metadata tagsets and metadata tags are disclosed elsewhere herein.

B. Example Host and Server Configurations

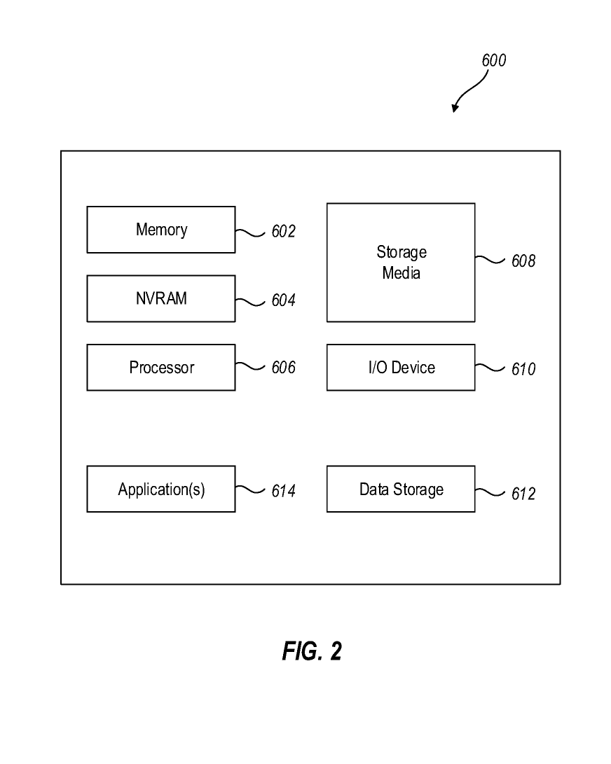

Turning now to FIG. 2, any one or more of the clients 200, storage appliance 300, backup server 400, and components of the data protection system 500, including the filesystem 502 and storage 504, can take the form of a physical computing device, one example of which is denoted at 600. As well, where any of the aforementioned elements comprise or consist of a VM, that VM may constitute a virtualization of any combination of the physical components disclosed in FIG. 2.

In the example of FIG. 2, the physical computing device 600 includes a memory 602 which can include one, some, or all, of random access memory (RAM), non-volatile random access memory (NVRAM) 604, read-only memory (ROM), and persistent memory, one or more hardware processors 606, non-transitory storage media 608, I/O device 610, and data storage 612. One or more of the memory components of the physical computing device can take the form of solid state device (SSD) storage. As well, one or more applications 614 are provided that comprise executable instructions. Such executable instructions can take various forms including, for example, a metadata tag subsystem.

C. Aspects of an Example Architecture

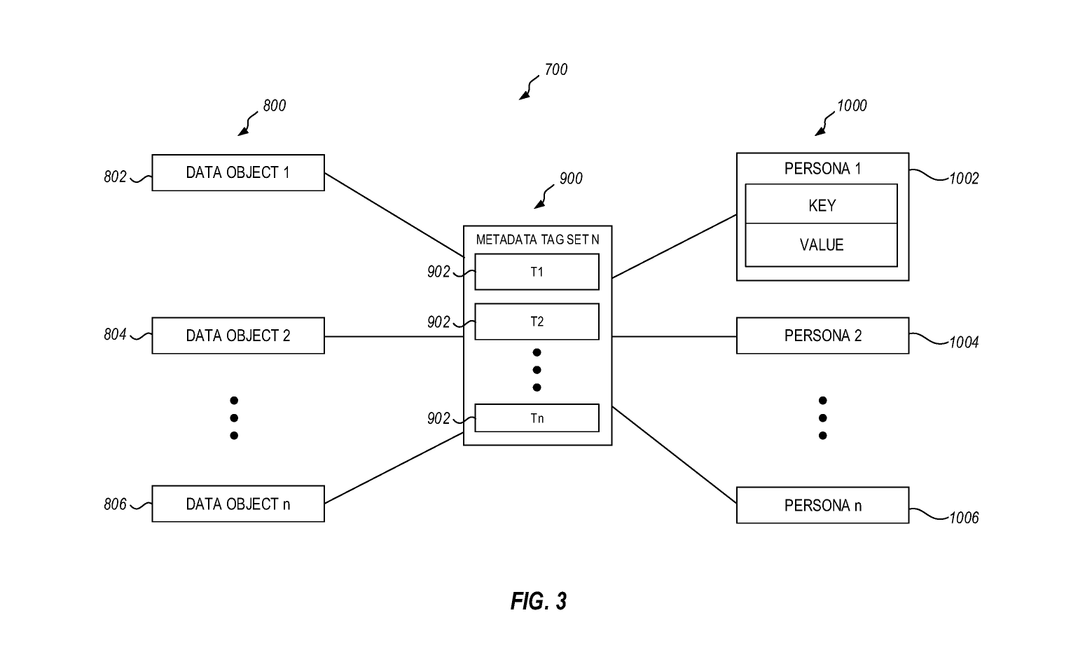

With particular reference now to FIGS. 3-5, details are provided concerning an example architecture 700 that includes one or more objects 800, a metadata tagset 900, and one or more personas 1000. Any or all of the functions in the following discussion may be performed by, and/or at the direction of, a metadata tag subsystem, such as the metadata tag subsystem 304 of a storage appliance such as storage appliance 300. As well, the metadata tags and the personas may be user defined, and a user may determine which metadata tags are assigned to which object(s) and may likewise determine which personas are assigned with a particular metadata tagset. These functions may be accomplished by way of a metadata tag subsystem hosted on a storage appliance.

In general, and with reference first to FIG. 3, a given metadata tagset 900 may be defined to include ‘n’ metadata tags ‘T’ 902, where n≥1. In some embodiments, the metadata tagset 900 may be stored in a storage appliance, such as the storage appliance 300 for example. Individual metadata tags, such as may be defined and implemented in connection with a metadata tagset 900, may also be stored in the storage appliance.

The metadata tagset 900 may be associated with one or more of the objects 800. There is no limit to the number of tags that can be assigned to a particular object. Thus, when one or more of the metadata tags 902 are searched, any and all objects 802, 804 and 806 that are associated with the metadata tagset 900 will appear in the search results. Searching based on metadata tags 902 may be performed, for example, at a client, such as a client 200, that is in communication, whether directly or indirectly, with a data protection environment, such as the data protection environment 500, where the objects with which those metadata tags 902 are stored. Such searching may alternatively be performed by, or at the direction of, a storage appliance, such as the storage appliance 300 for example.

As further disclosed in FIG. 3, a variety of different personas 1000, such as personals 1002, 1004 and 1006, may employ the metadata tagset 900 in order to locate and access one or more of the objects 800. Thus, the metadata tagset 900 enables each of the personas 1000 access to the objects 800 associated with the metadata tagset 900, notwithstanding that each persona 1000 may employ a different respective access method or protocol to locate and access an object 800. One illustrative example of this notion concerns the use of logical unit numbers (LUN), which are used to identify a logical unit, that is, a device addressed by a protocol such as the Small Computer System Interface (SCSI), or Storage Area Network (SAN) protocols which embrace SCSI. One example of such a protocol is the Fibre Channel (RC) communications protocol.

In some systems, a LUN may be referred to using a universally unique identifier (UUID), and may be implemented as a file in the filesystem. When an object is considered or ‘viewed’ as a LUN, the metadata tags associated with the object, that is, the LUN, use a LUN namespace such as “vdisk” whose persona key is the UUID. In this case, the LUN could be searched for and accessed based on the LUN namespace and UUID persona key. On the other hand, when the LUN is considered or ‘viewed’ as a file, the metadata tags associated with the LUN use a “file” namespace whose persona key is the file path. In this case, the LUN could be searched for and accessed based on the file namespace and file path. In both cases however, the underlying object, that is, the LUN, is the same. Thus, the metadata tagset associated with the LUN enables each of the different personas access to the LUN associated with the metadata tagset, notwithstanding that the two personas each employ a different respective access method or protocol to locate and access the LUN.

As one further example of this concept, a SQL database might store a table in the LUN. Thus, a “dbtable” namespace could be used to add a persona to the tagset discussed above in the LUN example, so that the same tagset is seen for each of the SQL database table, LUN and file.

With the foregoing illustrative examples in view, each persona 1000 may comprise, or consists of, a key-value combination, one example of which is a namespace-name combination. To give some more particular examples, one or more objects may have, or otherwise be associated with, a persona that includes a combination of an administrative namespace “admin” and a user-defined string such as “MANAGEMENT.CONFIG” or “GUI.BACKUP-INTERVAL,” where “admin” is the key, and the particular value of that key is “MANAGEMENT.CONFIG” or “GUI.BACKUP-INTERVAL.” Another example persona may include a combination of a file namespace “file” and a name, or path, such as “/data/col1/backup/blurtle” or “/ddvar/logs/mylog,” where “file” is the key, and the particular value of that key is “/data/col1/backup/blurtle” or “/ddvar/logs/mylog.” As indicated by these examples, any particular key may have multiple associated values, and each different key-value combination defines a specific persona.

As well, it is noted that different personas may be associated with different respective semantics, or rules concerning the handling of metadata tagsets and personas relating to an object. To illustrate, if an object such as a file is removed from a database for example, the semantics of the personas associated with that object may dictate that any metadata tagset corresponding to that object should likewise be deleted. As another example, there may be no, or different, semantics for personas that are associated with an administrative namespace.

Another example of semantics that may be employed concerns the use of data structures such as Mtrees. For example, a file namespace, some examples of which were noted above, may have the key format “/data/col1/<mtree>/[path].” Other example file namespaces may have key formats such as “/data/col1/backup/blurtle” or “LSU/filename.” As indicated by these examples, persona keys may take the form of a path. Moreover, in cases where an object has a persona in the “file” namespace whose key references an Mtree, such as in one of the preceding examples, those objects may be associated with additional semantics relating to the handling of the objects. For example, such an object may be replicated with the Mtree, and/or may be sent to cloud tier storage together with the Mtree.

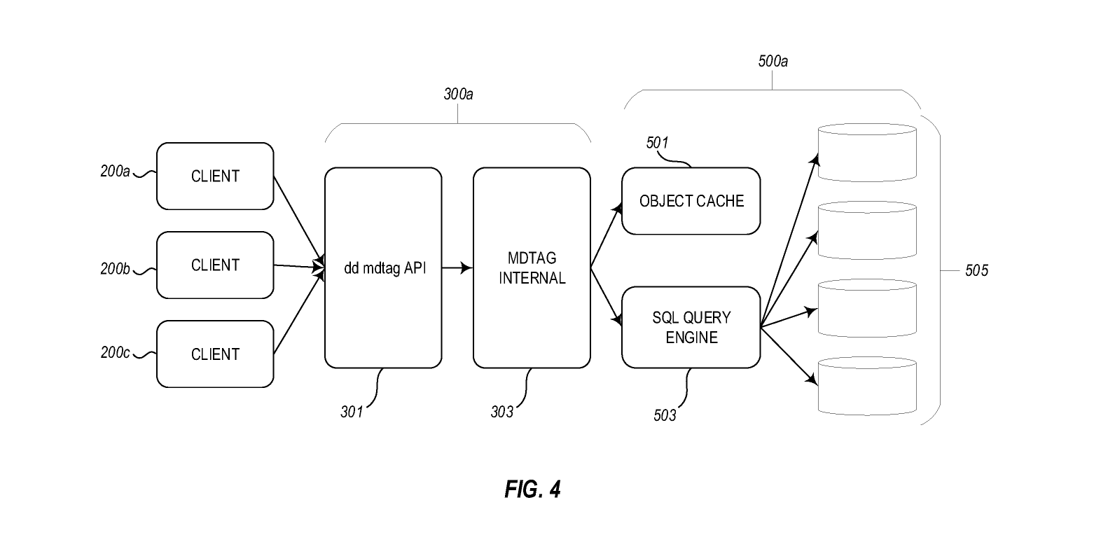

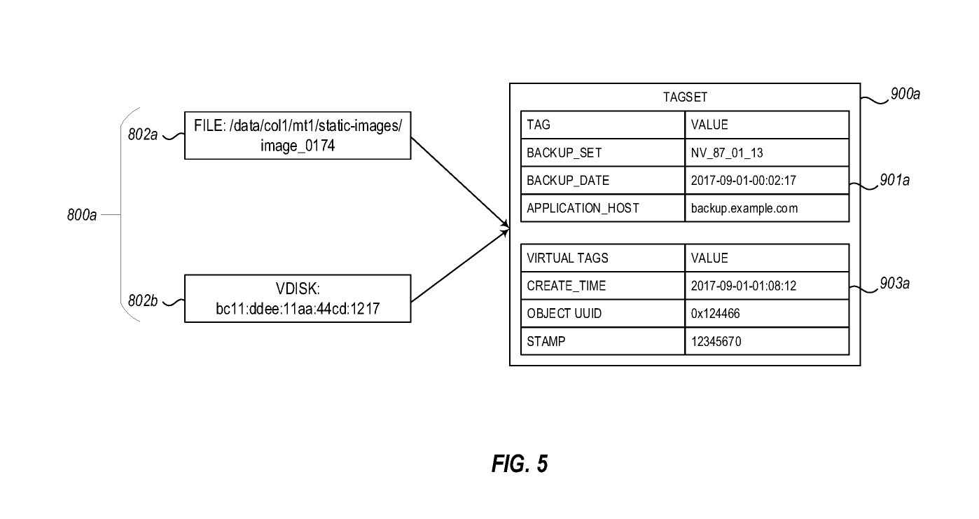

With continued reference to FIG. 3, and directing attention to FIGS. 4 and 5 as well, further details are provided concerning some example architectures. In FIG. 4, one or more clients 200a, 200b and 200c are configured to communicate with a storage appliance 300a by way of an application program interface (API) 301. The API 301 in turn, communicates with a metadata tag subsystem ‘MDTAG’ 303 that may be similar, or identical, to the metadata tag subsystem 304. The API 301 may implement a variety of functions, including for example, validation and error checking. In general, the metadata tag subsystem ‘MDTAG’ 303 implements metadata tag and object manipulation logic. To these ends, the metadata tag subsystem 303 may access a variety of different storage elements, one, some, or all, of which may comprise elements of a data protection environment 500a. For example, an object cache 501 may be provided that is accessible by way of the metadata tag subsystem 303 and stores recently used objects for later reuse. As well, the data protection environment 500a may include a query engine 503, such as a SQL query engine for example, that is operable to access a metadata tag database 505 in FIG. 4. In some embodiments, the metadata tags are not stored separately in a database, but are stored together with the object(s) with which the metadata tags are associated.

Directing attention now to FIG. 5, and with continued attention to FIGS. 3 and 4, further examples of objects 800a and a metadata tagset 900a are disclosed. As indicated in the examples, an object 800a may take the form of a file 802a, and may also be virtual in nature and, as such, can be a virtual object, such as a virtual disk 802b. Similarly, metadata tags 901a assigned to objects may identify various attributes of the object, or objects, to which they are assigned. As well, other metadata tags may take the form of virtual metadata tags, such as virtual metadata tags 903a that may be assigned to real objects or virtual objects. To illustrate, one example key, or metadata tag, might be ‘BACKUP_DATE,’ and the corresponding value may be ‘2017-09-01-00:02:17.’ Other examples are set forth in FIG. 5.

D. Aspects of Example Metadata Tags and Objects

With continued reference to the Figures and preceding discussion, further details are provided concerning examples of metadata tags and objects. In general, metadata is data that describes data. Metadata may include various basic attributes concerning an objection such as, for example, the identity of the file owner, size of the file, creation time of the file. Metadata may additionally, or alternatively, comprise or consist of various extended attributes, examples of which include name/value pairs associated with objects, Oracle SQL Data Modeler (DM) DM extended attributes, and virtual disk (VDISK) kernel-based virtual machine (KVM) pairs.

While conventional approaches may require that the identity of the object be known in order to access the metadata associated with that object, embodiments of the invention are not so constrained. Likewise, embodiments of the invention are not limited to object searches performed in accordance with a specific access method or protocol.

Rather, embodiments of the invention provide for searchable metadata tags (MDTAG) that may be stored in a tag store that may be queried by representational state transfer (REST) interfaces, or other interfaces. The metadata tags are automatically indexed, such as by a storage appliance, and searchable by multiple different criteria. As such, embodiments of the invention enable cross-protocol integration, and are scalable to suit any number of objects, metadata tags, and personas.

Among other things, the creation and use of metadata tags as contemplated by this disclosure may enable management, such as deleting, storing, and archiving, of objects based on the metadata tags that have been applied to those objects. As the foregoing suggests, the metadata tags enable implementation of object lifecycle policies for a particular object, or group of objects. The metadata tags may also be used to implement access control schemes, and encryption schemes, for an object or group of objects. Following is a brief overview of metadata tags and search considerations.

Similar to personas, a metadata tag may take the form of a key-value pair, although that is not necessarily required. The metadata tags may be stored in an element of a data protection environment, such as a storage appliance for example. As noted elsewhere herein, one example of a data protection is the Dell-EMC DataDomain data protection environment, although the scope of the invention is not limited to this particular example. In at least some embodiments, the metadata tag keys and values are defined at runtime by application clients, such as applications 202a for example, and are then stored at a storage appliance.

In some embodiments, the metadata tag keys may take the form of UTF-8 (variable width encoding using 1 to 48-bit bytes) names, although that is not required. Metadata tag values may take the form of strings, integers, or binary large OBject (BLOB). Example BLOBs include images, audio files, or multimedia objects. However, no particular form of metadata tag keys or metadata tag values is required.

As disclosed elsewhere herein, the metadata tags may be grouped into metadata tagsets, and can be updated atomically, that is, updated all together at the same time. This updating may be performed by the storage appliance in some embodiments. Updating a metadata tagset may include adding, deleting, and/or changing one or more metadata tags. Updates may be performed automatically in response to the occurrence of other events, such as the addition, deletion, or modification, of one or more objects, including objects stored in a data protection environment.

Metadata tags according to various embodiments of the invention can be searched in any of a variety of ways. This is consistent with the fact that embodiments of the invention are not limited to any particular type of access method or protocol. Following are some example search methodologies: search by tag existence (tag with a given name is present or not); search by tag name/value (for example, a value with operators such as >, >=, <, <=, !=e); search by a specific object name (for example, file path); search by system tags (for example, collection, UUID, stamp, or create-time); and, search by multiple criteria together using one or more *AND* operators. One example of a search definition using multiple criteria with *AND* operators might take the form: “find all tagged objects that have a tag ‘RMAN_BACKUP’ AND have a tag ‘CLIENT_ID’ with value ‘examplelexample.com’ AND were modified since 2017-01-01-00-00-00.” Other operators, such as NOT and OR, may also be used to in the definition of metadata tag searches.

Searches for metadata tags can be initialized by an application at a client, such as client 200 for example, and/or initialized at a storage appliance such as by a metadata tag subsystem. As well, search results can be stored and/or processed at either, or both, of a client and a storage appliance.

E. Aspects of Example Methods

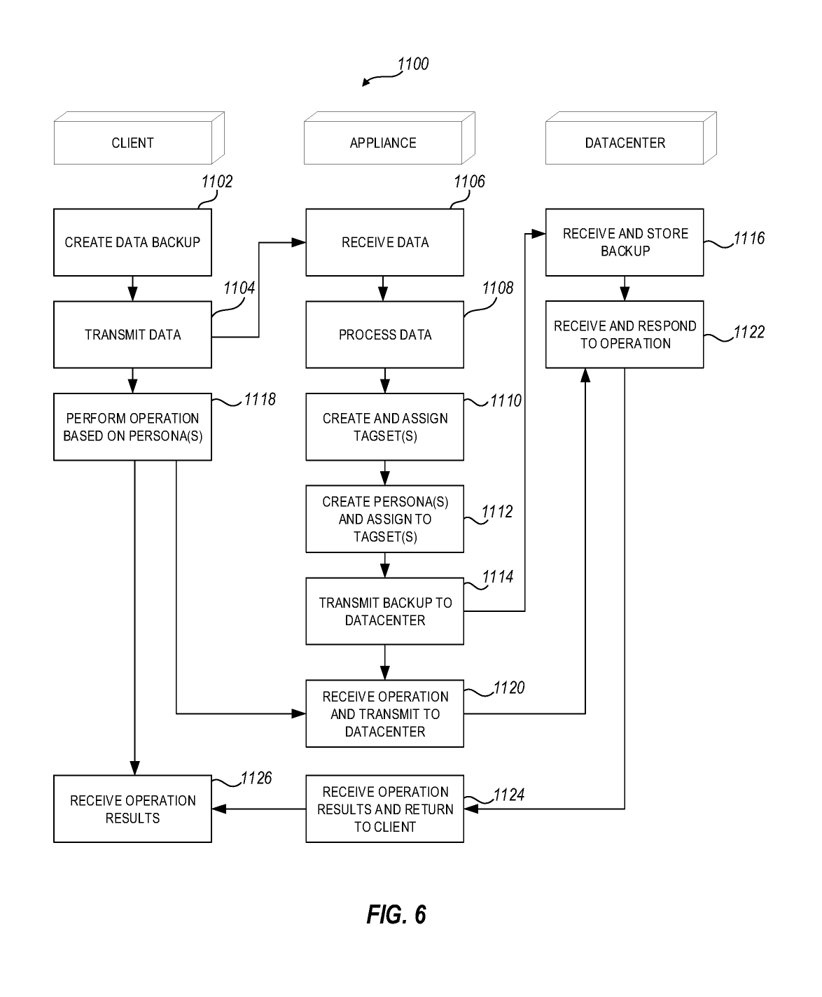

With reference now to FIG. 6, details are provided concerning some methods relating to the creation and use of metadata tagsets and personas, where one example method is denoted generally at 1100. As shown, the method 1100 may be performed cooperatively by one or more clients, a storage appliance, and a datacenter. It should be noted that the allocation of functions disclosed in FIG. 6 is provided only by way of example, and the functions can be allocated in any other suitable way. For example, the creation of tagsets and personas may be performed at the client, rather than at the storage appliance. Thus, the example functional allocation disclosed in FIG. 6 is not intended to limit the scope of the invention in any way.

The method 1100 may begin when a client creates 1102 data that is to be backed up. This process may be performed in conjunction with a backup application of a backup server. The backup is then transmitted 1104 to the storage appliance which receives 1106 the backup and may perform some processing 1108 on the backup. Such processing, which may or may not be performed, may include data deduplication. After the processing 1108 is completed, one or more tagsets may be created and assigned 1110 to various objects in the backup dataset. At, or about, the same time that the tagsets are created, one or more personas may be created and assigned to one or more of the tagsets 1112. In some embodiments, one or both of 1110 and 1112 may be performed, either at the client or at the storage appliance, prior to the creation of the backup 1102. As well, the tagsets and personas may be stored at the storage appliance, or may be transmitted to the datacenter 1114 for storage along with the backup.

In any case, the backup is received and stored 1116 at the datacenter. At some point, an application at the client may perform, or request the performance of, one or more operations 1118 with regard to the backed up data. Such operations may include, for example, any one or more of a query, a read request, a write request, or a delete request. The operation, or the request for the operation, may identify the tagset(s) and persona(s) corresponding to the object(s) in connection with which the operation is to be performed.

The request for the operation may be received 1120 at the storage appliance and forwarded to the datacenter which then receives and performs the requested operation with respect to the backed up data. The requested operation may be performed 1122 by the data center using, or at least based upon, the tagset(s) and persona(s) corresponding to the object(s) in connection with which the operation is to be performed. As well, the data center may respond 1122 in some manner to the requested operation. For example, the data center may return query results, or may return a confirmation that a read, write, or delete operation has been performed. Where the operation is a query, for example, the query can be performed by a storage appliance or a datacenter. As well, an object identified by a query may be accessed, directly or indirectly, by the client or the storage appliance. For example, the object may be accessed indirectly by the client by way of the storage appliance. As another example, the object may be accessed indirectly by the storage appliance by way of the datacenter. In still other examples, the client or the storage appliance may directly access the object at the datacenter.

In any case, the response of the datacenter may be received 1124 at the storage appliance and conveyed to the client where it is received 1126. At this point, the method 1100 may terminate.

While not specifically illustrated in FIG. 6, the stored tagsets and personas may be modified or deleted, for example by a user by way of a command line interface (CLI) or other interface at the storage appliance or client. As noted earlier, new tagsets and personas may be created and stored at the storage appliance, or stored at the datacenter, or created at the client. In some embodiments, the storage appliance may be omitted, and the storage appliance functions disclosed herein, and in FIG. 6 for example, may be performed by the client and/or the datacenter, and/or by a backup server. To illustrate with some examples, any one or more of 1106, 1108, 1114, 1120 and 1124 may be performed by a backup server, while either or both of 1110 and 1112 may be performed at a client. These examples may also apply when a storage appliance is employed, such that some of the processes are performed by the storage appliance, while others of the processes are performed by a client or a datacenter.

F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or other machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising performing the following operations:
creating a tagset comprising a plurality of metadata tags;
associating the tagset with an object that resides in a plurality of namespaces;
creating a first persona and a second persona, wherein from a perspective of the first persona, the object is a first type of object, and from a perspective of the second persona, the object is a second type of object;
enabling improved user access to the object by associating the first persona and the second persona with the tagset so that the object is accessible using both a first access method associated with the first persona and using a second access method associated with the second persona; and
accessing, directly or indirectly, the object using one or both of the first persona and the second persona.

2. The method as recited in claim 1, wherein part or all of the method is performed by a storage appliance.

3. The method as recited in claim 1, wherein the first persona and the second persona each comprise a different key-value combination.

4. The method as recited in claim 1, wherein each of the metadata tags comprises a tag-value combination.

5. The method as recited in claim 1, wherein accessing the object comprises reading and/or modifying the object.

6. The method as recited in claim 1, wherein the method is performed at least in part by a metadata tag subsystem that includes an application program interface (API) by way of which the metadata tag subsystem communicates with one or more client devices.

7. The method as recited in claim 1, wherein the tagset and personas are stored at a storage appliance.

8. The method as recited in claim 1, wherein accessing the object comprises searching for the object using one or more of the metadata tags.

9. The method as recited in claim 1, wherein the first persona comprises a combination of an administrative namespace and a user-defined string, and the second persona comprises a combination of a file namespace and a path.

10. The method as recited in claim 1, further comprising modifying or removing one of the metadata tags in the tagset.

11. The method as recited in claim 1, wherein one of the metadata tags in the tagset is a user-defined tag, and another of the metadata tags in the tagset is a virtual tag.

12. A non-transitory storage medium having stored therein computer-executable instructions which, when executed by one or more hardware processors, perform the following operations:
creating a tagset comprising a plurality of metadata tags;
associating the tagset with an object that resides in a plurality of namespaces;
creating a first persona and a second persona, wherein from a perspective of the first persona, the object is a first type of object, and from a perspective of the second persona, the object is a second type of object;
enabling improved user access to the object by associating the first persona and the second persona with the tagset so that the object is accessible using both a first access method associated with the first persona and using a second access method associated with the second persona; and
accessing, directly or indirectly, the object using one or both of the first persona and the second persona.

13. The non-transitory storage medium as recited in claim 12, wherein the first persona and the second persona each comprise a different key-value combination

14. The non-transitory storage medium as recited in claim 12, wherein each of the metadata tags comprises a tag-value combination.

15. The non-transitory storage medium as recited in claim 12, wherein accessing the object comprises reading and/or modifying the object.

16. The non-transitory storage medium as recited in claim 12, wherein accessing the object comprises searching for the object using one or more of the metadata tags.

17. The non-transitory storage medium as recited in claim 12, wherein the first persona comprises a combination of an administrative namespace and a user-defined string, and the second persona comprises a combination of a file namespace and a path.

18. The non-transitory storage medium as recited in claim 12, wherein the operations further comprise modifying or removing one of the metadata tags in the tagset.

19. The non-transitory storage medium as recited in claim 12, wherein one of the metadata tags in the tagset is a user-defined tag, and another of the metadata tags in the tagset is a virtual tag.

20. A computing device comprising:
one or more hardware processors; and
the non-transitory storage medium as recited in claim 12.
